(19) United States
(12) Patent Application Publication
(10) Pub. No.: US 2014/0070437 A1
(43) Pub. Date: Mar. 13, 2014

(54) MOLD CLEANING APPARATUS AND MOLD CLEANING METHOD

(71) Applicant: KABUSHIKI KAISHA TOSHIBA, Tokyo (JP)

(72) Inventor: Takumi OTA, Kanagawa-ken (JP)

(73) Assignee: KABUSHIKI KAISHA TOSHIBA, Tokyo (JP)

(21) Appl. No.: 13/767,080

(22) Filed: Feb. 14, 2013

(30) Foreign Application Priority Data
Sep. 7, 2012 (JP) 2012-197808

(51) Int. Cl. B29C 33/72

(52) U.S. Cl. CPC B29C 33/72
USPC 264/39; 425/135

(57) ABSTRACT

According to one embodiment, a mold cleaning apparatus includes a holding unit, a medium supply unit, an energy supply unit and an energy control unit. The holding unit is configured to hold a mold including at least a concave pattern provided on a first surface of a base material. The mold is held with the first surface directed downward. The medium supply unit is configured to supply a medium to the concave pattern. The energy supply unit is configured to supply energy toward the mold from opposite side from the first surface of the base material. The energy control unit is configured to control amount of the energy reaching the concave pattern.

### CROSS-REFERENCE TO RELATED APPLICATIONS

This application is based upon and claims the benefit of priority from the prior Japanese Patent Application No. 2012-197808, filed on Sep. 7, 2012; the entire contents of which are incorporated herein by reference.

### FIELD

Embodiments described herein relate generally to a mold cleaning apparatus and a mold cleaning method.

### BACKGROUND

With regard to pattern formation, a technique for transferring a fine pattern called the imprint method has been drawing attention. The imprint method uses a mold provided with a concave-convex shape of the pattern to be formed. In the mold used in the imprint method, a concave-convex pattern is formed in the surface of a light transmissive base material such as quartz. The concave-convex pattern of the base material is formed by forming a resist pattern on the surface of the base material by e.g. the electron beam lithography method and then etching the base material.

In pattern formation using a mold, foreign matter attached to the concave-convex pattern may cause failures in the pattern formed by the transfer. In the imprint method, which repetitively uses a mold, mold cleaning is important.

### BRIEF DESCRIPTION OF THE DRAWINGS

FIG. 1 is a schematic view illustrating the configuration of a mold cleaning apparatus according to a first embodiment;

FIGS. 2A and 2B are schematic views illustrating the configuration of a mold;

FIG. 3 is a schematic view illustrating the removal of foreign matter;

FIG. 4 is a flow chart illustrating the mold cleaning method; and

FIGS. 5A to 5E are schematic sectional views illustrating an imprint method.

### DETAILED DESCRIPTION

In general, according to one embodiment, a mold cleaning apparatus includes a holding unit, a medium supply unit, an energy supply unit and an energy control unit. The holding unit is configured to hold a mold including at least a concave pattern provided on a first surface of a base material. The mold is held with the first surface directed downward. The medium supply unit is configured to supply a medium to the concave pattern. The energy supply unit is configured to supply energy toward the mold from opposite side from the first surface of the base material. The energy control unit is configured to control amount of the energy reaching the concave pattern.

Various embodiments will be described hereinafter with reference to the accompanying drawings. In the following description, like members are labeled with like reference numerals. The description of the members once described is omitted appropriately.

### First Embodiment

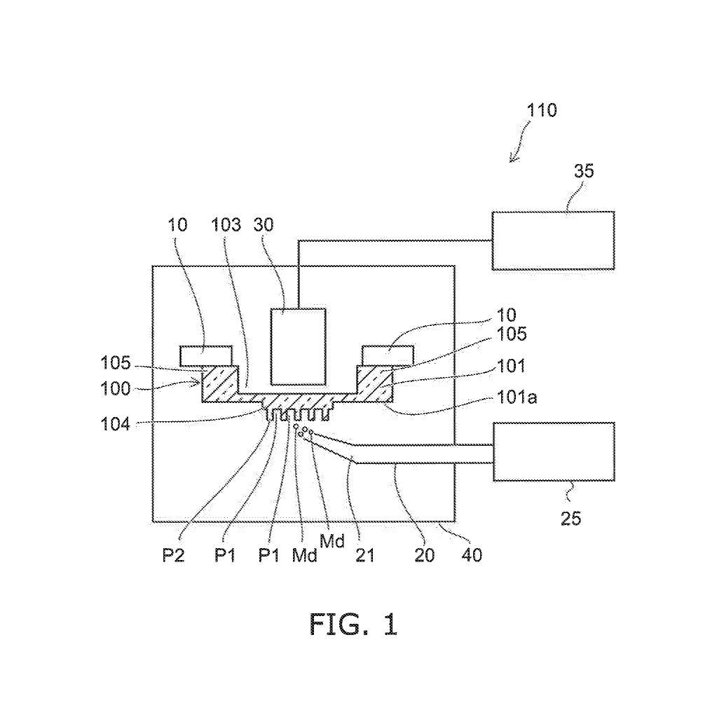

FIG. 1 is a schematic view illustrating the configuration of a mold cleaning apparatus according to a first embodiment.

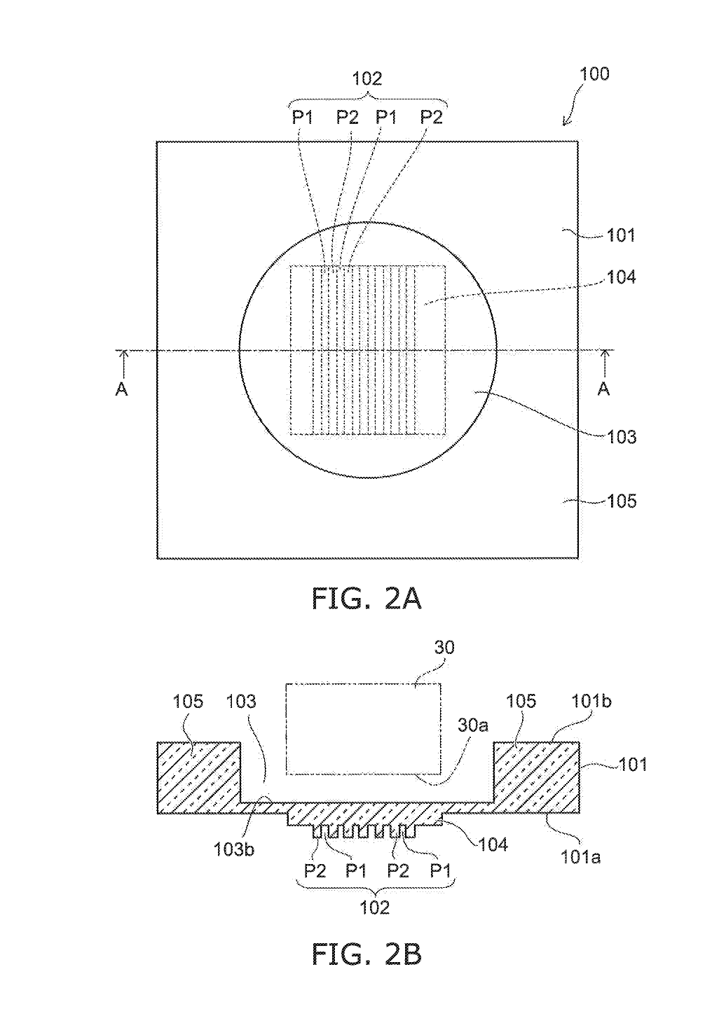

FIGS. 2A and 2B are schematic views illustrating the configuration of a mold.

FIG. 2A is a plan view of the mold 100. FIG. 2B is a sectional view taken along line A-A of FIG. 2A.

As shown in FIG. 1, the mold cleaning apparatus 110 according to the first embodiment is an apparatus for cleaning a mold 100 used in the imprint method. The mold cleaning apparatus 110 includes a holding unit 10, a medium supply unit 20, an energy supply unit 30, and an energy control unit 35.

The holding unit 10 is a unit for holding the mold 100. The medium supply unit 20 is a unit for supplying a medium Md toward the mold 100. The medium Md is at least one of liquid and gas. The energy supply unit 30 is a unit for supplying energy toward the mold 100.

In the mold cleaning apparatus 110, the medium Md supplied to the mold 100 is activated by energy to remove foreign matter in the concave pattern P1. The energy is supplied from the opposite side of the mold 100 from the side where the concave pattern P1 is formed. That is, the energy is attenuated before reaching the concave pattern P1. Thus, only the foreign matter is removed without affecting the concave pattern P1.

Here, the mold 100 cleaned by the mold cleaning apparatus 110 is described.

As shown in FIGS. 2A and 2B, the mold 100 includes a base material 101 and a pattern portion 102. The base material 101 has a first surface 101a. The pattern portion 102 is provided at the first surface 101a and includes at least a concave pattern P1.

On the opposite side of the base material 101 from the region where the concave pattern P1 is formed, a recess 103 is provided. For instance, the recess 103 is a partly removed portion of a second surface 101b on the opposite side from the first surface 101a of the base material 101. Outside the recess 103 of the base material 101, a peripheral portion 105 is provided.

On the opposite side from the bottom surface 103b of the recess 103 of the base material 101, a pedestal portion 104 is provided. The pedestal portion 104 is provided in a shape protruding from the first surface 101a. The pattern portion 102 is provided on the pedestal portion 104. The pattern portion 102 includes at least one concave pattern P1. The concave pattern P1 is provided in e.g. a line shape extending in one direction. The concave pattern P1 may be provided in an island shape with an opening shaped like a circle, ellipse, oval, rectangle and the like. In the case of providing a plurality of concave patterns P1, a convex pattern P2 is provided between two adjacent concave patterns P1.

The plan view outline of the base material 101 is e.g. a rectangle approximately 150 millimeters (mm) long and approximately 150 mm wide. The plan view outline of the recess 103 is e.g. a circle having a diameter of approximately 50 mm. The plan view outline of the pedestal portion 104 is e.g. a rectangle 32 mm long and 26 mm wide. The height of the pedestal portion 104 is approximately 30 micrometers (μm). The thickness of the portion of the recess 103 of the base material 101 where the pedestal portion 104 is not provided is approximately 1 mm. The thickness of the peripheral portion 105 of the base material 101 is approximately 6 mm.

The depth of the concave pattern P1 is e.g. 50 nanometers (nm) or more and 70 nm or less. The width of the concave pattern P1 is e.g. 10 nm or more and 20 nm or less. The height of the convex pattern P2 is approximately 50 nm or more and 70 nm or less. The width of the convex pattern P2 is approximately 10 nm or more and 20 nm or less. In the pattern portion 102, for instance, a line-and-space pattern made of a plurality of convex patterns P2 and a plurality of concave patterns P1 is provided.

In the mold cleaning apparatus 110 shown in FIG. 1, the holding unit 10 holds the mold 100 by e.g. vacuum chucking the peripheral portion 105 of the base material 101. The holding unit 10 may hold the mold 100 by vertically or horizontally grasping the peripheral portion of the base material 101.

The holding unit 10 holds the mold 100 with the first surface 101a of the base material 101 directed downward. That is, when the mold 100 is held by the holding unit 10, the first surface 101a of the base material 101 faces downward, and the second surface 101b faces upward. The holding unit 10 may obliquely hold the mold 100. In this case, the mold 100 is held so that the first surface 101a of the base material 101 is located below the second surface 101b of the base material 101.

Although not shown in FIG. 1, the mold cleaning apparatus 110 includes a transport unit for transporting the mold 100 to be cleaned. The transport unit transports the mold 100 to be cleaned from outside the apparatus to the holding unit 10.

The medium supply unit 20 supplies a medium Md to the concave pattern P1 of the mold 100 held by the holding unit 10. The medium supply unit 20 includes e.g. a nozzle 21. Toward the first surface 101a of the base material 101 directed downward, the nozzle 21 jets the medium Md upward. If the first surface 101a faces downward, excessive accumulation of the jetted medium Md on the first surface 101a is avoided. The medium supply unit 20 may supplies the medium Md to the concave pattern P1 by flooding method.

The medium Md is at least one of liquid, gas and bubble. The liquid can be at least one of e.g. ultrapure water (e.g., with a specific resistance of approximately 18 MΩ·cm), alkaline solution and alcohol. The gas can be e.g. an inert gas such as argon.

The energy supply unit 30 supplies energy toward the mold 100 from the opposite side from the first surface 101a of the base material 101. The tip 30a of the energy supply unit 30 is located in the recess 103 of the mold 100. The energy supplied from the energy supply unit 30 is transmitted from the bottom surface 103b of the recess 103 to the concave pattern P1 of the first surface 101a.

The energy supplied from the energy supply unit 30 is e.g. one of ultrasound and laser light. In the case where the energy is ultrasound, the energy supply unit 30 includes an ultrasound generating device. In the case where the energy is laser light, the energy supply unit 30 includes a laser light source (e.g., YAG (yttrium aluminum garnet) laser light source).

The mold cleaning apparatus 110 further includes a medium control unit 25, an energy control unit 35, and a processing bath 40. The medium control unit 25 controls e.g. the supply amount and supply timing of the medium Md supplied from the nozzle 21 of the medium supply unit 20.

The energy control unit 35 controls e.g. the amount and irradiation timing of the energy reaching the concave pattern P1. For instance, the energy control unit 35 performs at least one of controlling the amount of energy emitted from the tip 30a of the energy supply unit 30, and controlling the distance between the tip 30a of the energy supply unit 30 and the concave pattern P1.

The processing bath 40 is provided at least below the mold 100 held by the holding unit 10 and the nozzle 21 of the medium supply unit 20. In this embodiment, the processing bath 40 is provided so as to surround the holding unit 10, the medium supply unit 20, and the energy supply unit 30. The processing bath 40 serves to receive the medium Md supplied from the medium supply unit 20.

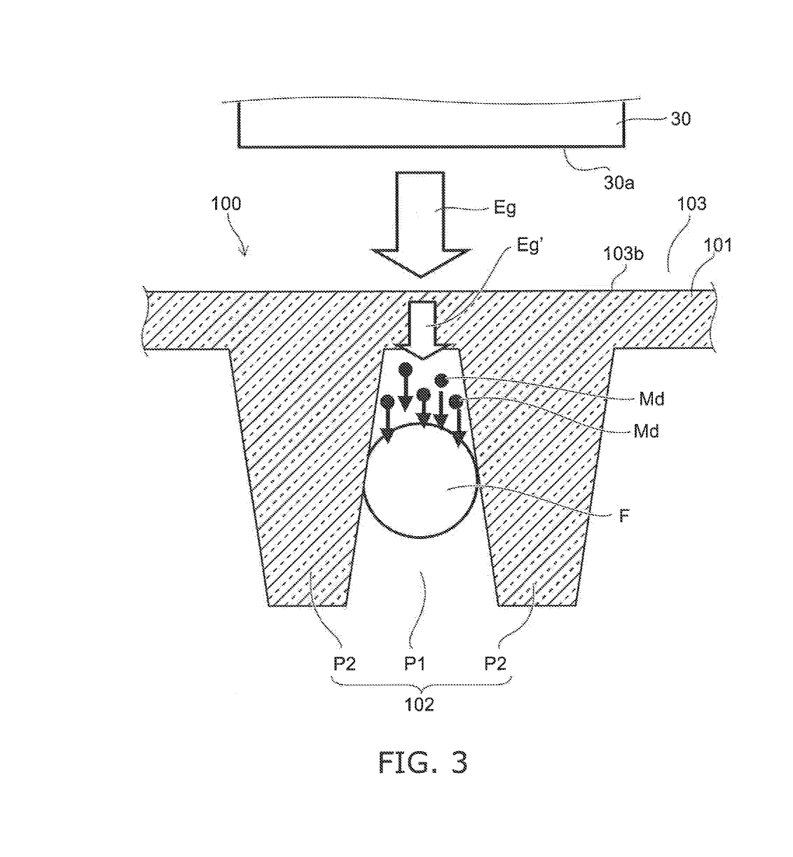

FIG. 3 is a schematic view illustrating the removal of foreign matter.

FIG. 3 shows the state in which foreign matter F is inserted in the concave pattern P1 of the mold 100. In the mold cleaning apparatus 110 according to this embodiment, a medium Md is supplied between the concave pattern P1 of the mold 100 and the foreign matter F. Energy Eg is supplied from the opposite side from the concave pattern P1 of the mold 100.

The tip 30a of the energy supply unit 30 is located in the recess 103 provided on the opposite side from the concave pattern P1 of the mold 100. For instance, the distance between the tip 30a of the energy supply unit 30 and the bottom surface 103b of the recess 103 is approximately 2 mm or more and 3 mm or less. For instance, the energy control unit 35 controls the distance between the energy supply unit 30 and the concave pattern P1 based on the distance between the tip 30a of the energy supply unit 30 and the bottom surface 103b of the recess 103. Thus, the energy control unit 35 adjusts the amount of energy Eg′ reaching the concave pattern P1.

In the mold cleaning apparatus 110 according to this embodiment, the tip 30a of the energy supply unit 30 is inserted in the recess 103 of the mold 100. Thus, the tip 30a can be made very close to the concave pattern P1. Accordingly, even in the case where a small amount of energy Eg is applied from the opposite side from the pattern portion 102 of the mold 100, sufficient energy Eg′ for removing the foreign matter F in the concave pattern P1 can be provided.

The energy Eg supplied from the energy supply unit 30 is attenuated in the base material 101 of the mold 100, but penetrated into the concave pattern P1. The energy Eg′ penetrated into the concave pattern P1 activates the medium Md filled in between the concave pattern P1 and the foreign matter F.

For instance, in the case where the energy is ultrasound, activation of the medium Md generates a cavitation in the medium Md. By this cavitation, the foreign matter F inserted in the concave pattern P1 is pushed out toward the opening of the concave pattern P1.

For instance, in the case where the energy is laser light, a laser-induced impact on the medium Md is generated. By this induced impact, the foreign matter F inserted in the concave pattern P1 is pushed out toward the opening of the concave pattern P1.

In the case of removing the foreign matter F by using cavitation of the medium Md, a medium allowing easy control of air bubbles generated by cavitation is preferably used as the medium Md.

The side surface of the concave pattern P1 is provided with a slope. For instance, the angle of the side surface of the concave pattern P1 with respect to the first surface 101a of the base material 101 is approximately 88° or more and 89° or less. The width of the concave pattern P1 becomes wider with the distance from the first surface 101a of the base material 101. By providing energy from the opposite side from the concave pattern P1 of the mold 100, the foreign matter F is pushed out to the direction in which the width of the concave pattern P1 becomes wider. Accordingly, the foreign matter F is easily removed from inside the concave pattern P1.

Thus, in the mold cleaning apparatus 110 according to this embodiment, using the recess 103 provided in the mold 100, foreign matter F is reliably removed from the concave pattern P1 even with a small amount of energy. The energy is applied in a small amount and from the opposite side from the concave pattern P1 of the mold 100. Thus, no breaks or defects occur in the concave pattern P1.

### Second Embodiment

Next, a mold cleaning method according to a second embodiment is described.

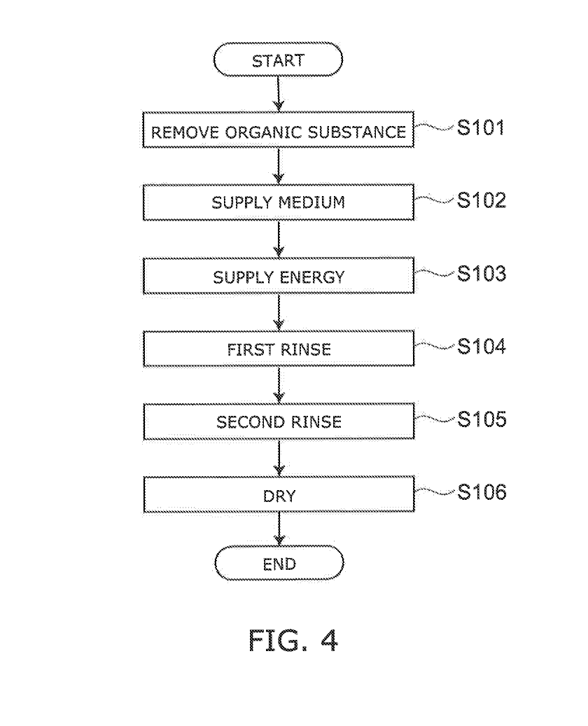

FIG. 4 is a flow chart illustrating the mold cleaning method.

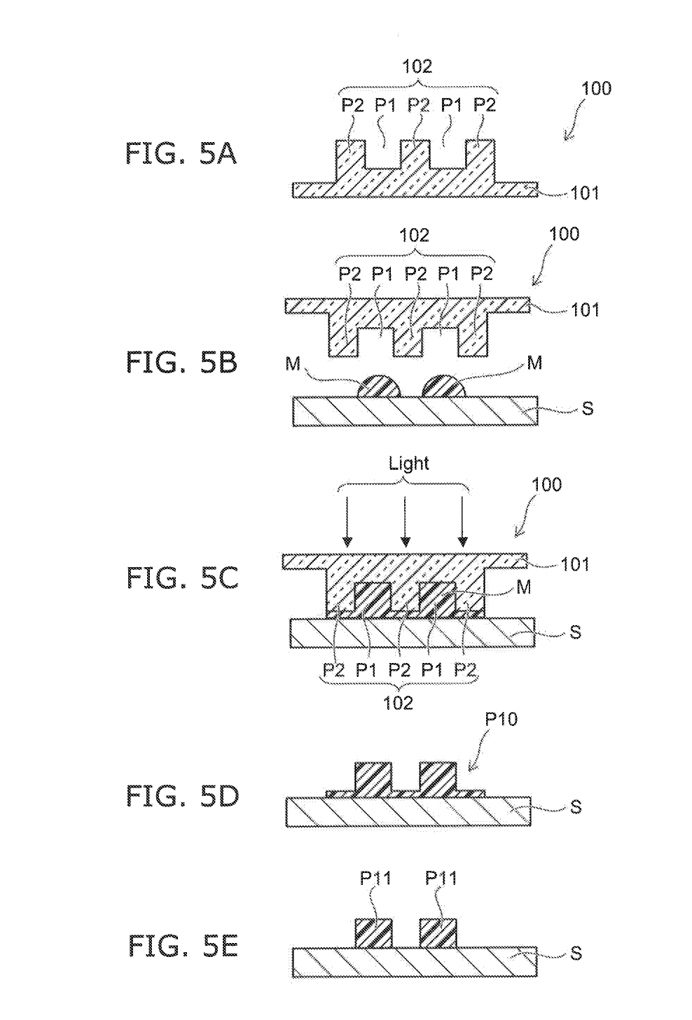

FIGS. 5A to 5E are schematic sectional views illustrating an imprint method.

Before describing the mold cleaning method according to this embodiment, an imprint method using a mold is described.

First, as shown in FIG. 5A, a mold 100 is prepared. The mold 100 includes a base material 101 made of a translucent material such as quartz, and a pattern portion 102 provided in the base material 101. The pattern portion 102 is formed by forming a resist pattern on the base material 101 by e.g. the electron beam lithography method, and then etching the base material 101. The pattern portion 102 includes at least a concave pattern P1.

Next, as shown in FIG. 5B, a photocurable material M is applied onto a substrate S. The material M is dropped onto the substrate S by e.g. the ink jet method. Then, as shown in FIG. 5C, the pattern portion 102 of the mold 100 is brought into contact with the material M on the substrate S. The material M is filled in the concave pattern P1 of the mold 100 by capillarity.

Next, as shown in FIG. 5C, light (e.g., ultraviolet light) is applied from the rear surface side (the side where the pattern portion 102 is not formed) of the mold 100. The light passes through the mold 100 and reaches the material M. Thus, the material M is cured. After the material M is cured, the mold 100 is released.

By releasing the mold 100, as shown in FIG. 5D, a transfer pattern P10 having an inverted pattern shape of the pattern portion 102 is formed on the substrate S. Next, the residual film provided on the substrate S side of the transfer pattern P10 is removed by e.g. RIE (reactive ion etching). Thus, as shown in FIG. 5E, a convex pattern P11 is formed on the substrate S.

In the imprint method, by repeating the steps shown in FIGS. 5B to 5E, the concave-convex shape of the pattern portion 102 of the mold 100 is transferred to the material M. Thus, the same pattern is repetitively formed.

As described above, in a pattern formation method based on the imprint method, the mold 100 is brought into contact with the material M. Thus, the material M may be attached as foreign matter F in the concave pattern P1 of the mold 100. Furthermore, the foreign matter F attached onto the substrate S may be moved to the mold 100 side. Foreign matter F attached to the mold 100 may incur the decrease of yield due to the influence of the foreign matter F. Thus, the mold 100 needs to be periodically cleaned.

As one of the cleaning methods, a mixed liquid of sulfuric acid and hydrogen peroxide water is used to dissolve the foreign matter F made of organic substance such as resin. Then, rinse is performed with an alkaline solution and pure water. Finally, residual chemicals are shaken out and dried.

Rinse with an alkaline solution and pure water serves to remove fine foreign matter. On the other hand, it is difficult to reliably remove foreign matter without damaging the mold 100 provided with a fine pattern.

Next, the mold cleaning method according to this embodiment is described.

As shown in FIG. 4, the mold cleaning method according to this embodiment includes the steps of supplying a medium (step S102) and supplying energy (step S103). In this embodiment, before the step of supplying a medium (step S102), the method further includes the step of removing organic substance (step S101). After the step of supplying energy (step S103), the method further includes a first rinse step (step S104), a second rinse step (step S105), and a drying step (step S106).

The step of removing organic substance (step S101) performs processing for cleaning the mold 100 with a mixed liquid of sulfuric acid and hydrogen peroxide water. This removes organic substance attached to the mold 100.

The step of supplying a medium (step S102) performs processing for supplying a medium Md to the concave pattern P1 of the mold 100. The medium Md is at least one of liquid and gas. The liquid can be e.g. ultrapure water (e.g., with a specific resistance of approximately 18 MΩ·cm). The gas can be e.g. an inert gas such as argon.

In the step of supplying a medium (step S102), the medium Md is preferably supplied toward the first surface 101a with the first surface 101a of the base material 101 of the mold 100 directed downward. This suppresses excessive accumulation of the supplied medium Md on the first surface 101a.

The step of supplying energy (step S103) performs processing for supplying energy toward the mold 100 from the opposite side from the first surface 101a of the base material 101 of the mold 100. The energy is e.g. one of ultrasound and laser light. In this embodiment, the energy is transmitted from the bottom surface 103b of the recess 103 of the mold 100 toward the concave pattern P1. The amount of energy is controlled by the supply amount of energy or the distance between the tip 30a of the energy supply unit 30 and the concave pattern P1.

The medium Md is activated by energy irradiation. For instance, in the case where the energy is ultrasound, the medium Md is activated and generates a cavitation. By this cavitation, the foreign matter F inserted in the concave pattern P1 is pushed out toward the opening of the concave pattern P1.

For instance, in the case where the energy is laser light, a laser-induced impact on the medium Md is generated. By this induced impact, the foreign matter F inserted in the concave pattern P1 is pushed out toward the opening of the concave pattern P1. Thus, the foreign matter F is removed from inside the concave pattern P1.

The first rinse step (step S104) performs processing for rinsing the mold 100 with an alkaline solution. Thus, even if the foreign matter F pushed out from inside the concave pattern P1 is reattached to the surface of the mold 100, such foreign matter F is reliably removed.

The second rinse step (step S105) performs processing for rinsing the mold 100 with e.g. ultrapure water. Thus, the alkaline solution attached to the mold 100 is removed. In the second rinse step, rinse is performed with a solution more neutral than the alkalinity of the alkaline solution used in step S104. Ultrapure water is most preferable.

The drying step (step S106) performs processing for drying e.g. the ultrapure water used in the second rinse step.

By these steps, cleaning of the mold 100 is performed.

In the mold cleaning method according to this embodiment as described above, the medium Md supplied to the mold 100 is activated by energy to reliably remove foreign matter F in the concave pattern P1. The energy is applied in a small amount and from the opposite side from the concave pattern P1 of the mold 100. Thus, no breaks or defects occur in the concave pattern P1.

As described above, the mold cleaning apparatus 110 and the mold cleaning method according to the embodiments can clean the mold 100 while suppressing breaks and defects in the pattern.

The embodiments and the variations thereof have been described above. However, the invention is not limited to these examples. For instance, the mold cleaning apparatus 110 described above may be stand-alone as a cleaning apparatus, or may be incorporated in an imprint apparatus. In the mold 100 to be cleaned, the base material 101 may be a hard material such as quartz, or may be a flexible material such as resin. Furthermore, those skilled in the art can modify the above embodiments by suitable addition, deletion, and design change of components, and by suitable combination of the features of the embodiments. Such modifications are also encompassed within the scope of the invention as long as they fall within the spirit of the invention.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A mold cleaning apparatus comprising:
a holding unit configured to hold a mold including at least a concave pattern provided on a first surface of a base material, the mold being held with the first surface directed downward;
a medium supply unit configured to supply a medium to the concave pattern;
an energy supply unit configured to supply energy toward the mold from opposite side from the first surface of the base material; and
an energy control unit configured to control amount of the energy reaching the concave pattern.

2. The apparatus according to claim 1, wherein a tip of the energy supply unit is located in a recess provided on opposite side of the base material of the mold from a region where the concave pattern is formed.

3. The apparatus according to claim 1, wherein the energy supply unit supplies ultrasound or laser light as the energy.

4. The apparatus according to claim 1, wherein the energy control unit controls supply amount of the energy.

5. The apparatus according to claim 1, wherein the energy control unit controls distance between the energy supply unit and the concave pattern.

6. The apparatus according to claim 1, further comprising:
a processing bath,
the processing bath being provided so as to surround the holding unit, the medium supply unit, and the energy supply unit.

7. A method for cleaning a mold including at least a concave pattern provided on a first surface of a base material, comprising:
supplying a medium to the concave pattern; and
activating the medium by supplying energy toward the mold from opposite side from the first surface of the base material,
in the supplying a medium, the medium being supplied toward the first surface with the first surface directed downward, and
in the activating the medium, supply amount of the energy being controlled.

8. The method according to claim 7, wherein in the activating the medium, a tip of an energy supply unit configured to supply the energy is located in a recess provided on opposite side of the base material of the mold from a region where the concave pattern is formed, and the energy is supplied.

9. The method according to claim 7, wherein in the activating the medium, distance between an energy supply unit configured to supply the energy and the concave pattern is controlled.

10. The method according to claim 7, wherein in the activating the medium, ultrasound or laser light is supplied as the energy.

11. The method according to claim 7, further comprising:
before the supplying a medium, cleaning the mold with a mixed liquid of an acid and hydrogen peroxide water.

12. The method according to claim 7, further comprising:
after the activating the medium, cleaning the mold with an alkaline solution.

13. The method according to claim 12, further comprising:
after the cleaning the mold with an alkaline solution, cleaning the mold with a solution more neutral than alkalinity of the alkaline solution.

14. The method according to claim 13, further comprising:
after the cleaning the mold with a solution more neutral than alkalinity of the alkaline solution, drying the neutral solution.

15. The method according to claim 13, wherein the solution more neutral than alkalinity of the alkaline solution is pure water.
